(19) United States
(12) Patent Application Publication
(10) Pub. No.: US 2008/0115650 A1
(43) Pub. Date: May 22, 2008

(54) Cutting Device And Method For Operating A Cutting Device

(76) Inventor: Manfred Richter, Waldbrunn (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/568,625

(22) PCT Filed: Feb. 25, 2005
(86) PCT No.: PCT/EP05/50802

§ 371 Date: Jul. 6, 2007

(30) Foreign Application Priority Data
May 3, 2004 (DE) 10 2004 021 653.3

(51) Int. Cl. B26D 5/00; B26D 1/00

(52) U.S. Cl. 83/821; 81/13

(57) ABSTRACT

A cutting device has a jacket member (22) embodied to selectively shield or expose a rotor commutator (6), and a cutting mechanism (24) fixed to the jacket member (22) having scissors (25) with a scissor (25) drive. The scissor (25) drive displaces the scissors (25) in an axial direction as well as in a direction having a radial component relative to the jacket member (22). The jacket member (22) is brought into a position in which it shields the commutator (6). After winding and fastening a wire into a winding element (4), the scissor (25) drive is triggered to move the scissors (25) in an axial and radial direction towards or beyond the axial end of the jacket member (22) via which the commutator (6) can be inserted into the jacket member (22). The scissor (25) blades (44, 46) are triggered to cut the wire while the scissor (25) drive is triggered to move the scissors (25)in the opposite direction.

### CROSS-REFERENCE TO RELATED APPLICATIONS

This application is a U.S. national stage application of International Application No. PCT/EP2005/050802 filed Feb. 25, 2005, which designates the United States of America, and claims priority to German application number DE 10 2004 021 653.3 filed May 3, 2004, the contents of which are hereby incorporated by reference in their entirety.

### TECHNICAL FIELD

The invention relates to a cutting device and a method for operating a cutting device which is suitable for severing a wire that is utilized for manufacturing a rotor.

### BACKGROUND

A rotor of this type preferably has a winding form in which slots are fashioned into which a wire is wound. The wire is hooked, at its respective end, on a respective hook of a commutator of the rotor and thus fixed to same. The rotor is preferably utilized in electric motors. A rotor of this type should be cost-effective to manufacture. The time needed to manufacture the rotor impacts on the costs of the manufacturing process.

### SUMMARY

The object of the invention is to create a cutting device and a method for operating the cutting device which enable simple and rapid cutting of a wire that is assigned, during the manufacturing of a rotor, to said rotor.

According to an embodiment, a cutting device may have a jacket member that is embodied so as to selectively shield or expose a commutator of a rotor, and a cutting mechanism that is fixed to the jacket member. The cutting mechanism can be provided with scissors and to which a drive is allocated, which drive is configured so as to displace the scissors in an axial direction relative to the jacket member as well as in a direction having a radial direction component relative to the jacket member.

### BRIEF DESCRIPTION OF THE DRAWINGS

Exemplary embodiments of the invention are explained in the following with reference to the schematic drawings, in which:

FIG. 1 shows a cutting device,

FIG. 2 shows a winding device with a rotor, and

FIG. 3 shows a further view of the cutting device as shown in FIG. 1.

Elements of identical construction or function are labeled with the same reference symbols across all the figures.

### DETAILED DESCRIPTION

According to an embodiment, in a method for operating the cutting device, the jacket member is brought into a position in which the same shields the commutator of the rotor. After winding a wire into a winding form of the rotor and then fastening the wire to a hook of the commutator, the drive for the scissors is activated in such a way that the scissors are moved in an axial and radial direction toward or beyond the axial end of the jacket member via which the commutator can be inserted into the jacket member. The blades of the scissors are activated in such a way that the wire is severed. The drive for the scissors is subsequently activated such that the scissors are moved in the opposite direction compared to before cutting the wire.

According to an embodiment, the scissors are arranged at a short distance from the wire fixed to the commutator hook and can therefore be positioned easily and with great accuracy relative to the rotor and moreover can also be positioned rapidly relative to said rotor. As a result, the operation of cutting the wire, which is usually necessary a number of times during the manufacturing of the rotor, can take place very rapidly and therefore the time needed to manufacture the rotor can be kept very short. Moreover, it is thus a simple matter to cut the wire very close to the hook of the commutator. As a result, it is a simple matter to make sure that the end of the wire protruding from the hook does not generate a short circuit with an adjacent wire winding. Thus, the cutting device can also be fashioned so as to be very compact.

According to an embodiment, the drive for the cutting mechanism may include a slideway member with a slideway that is fashioned such that an axial movement of an actuator of the drive for the scissors is converted into a movement of the scissors in an axial direction and then with a radial direction component if the movement is directed toward or beyond the axial end of the jacket member via which the commutator can be inserted into the jacket member. Thus, the actuator can be fashioned very simply; it only needs to enable movements in one axial direction.

According to a further embodiment, the slideway can be fashioned such that following the movement taking place with a radial direction component if the movement is directed toward or beyond the axial end of the jacket member via which the commutator can be inserted into the jacket member, a further axial movement of the scissors takes place. Thus, it is a simple matter to make sure that blades of the blades of the scissors enclose the wire effectively and thus precise severing of the wire takes place.

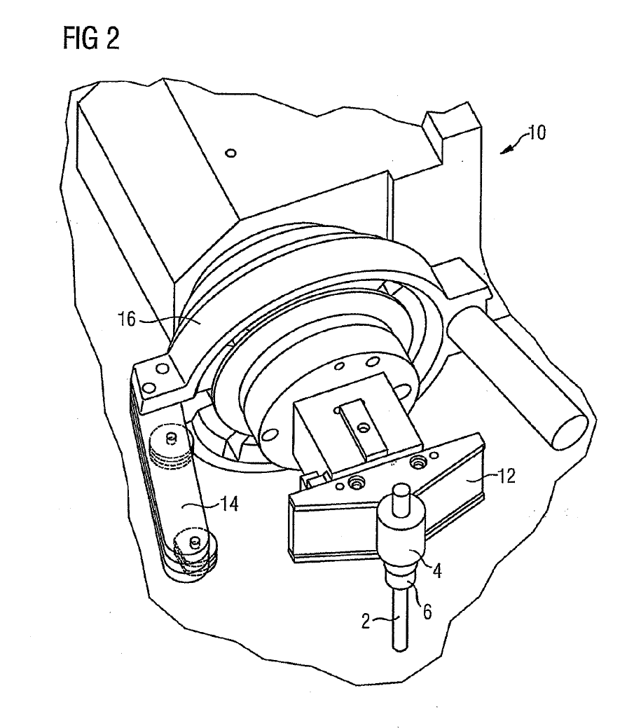

A rotor 1 (FIG. 2) has a shaft 2 on which a winding form 4 is mounted. The winding form 4 forms the poles of the rotor and accommodates wires in each case in slots, which wires are wound into coils there. The rotor 1 further includes a commutator 6, to which hooks 8 are in turn assigned, to which the wire is fixed in each case after winding or is also fixed before winding and that are electrically connected to segments of the commutator 6.

A winding device 10 includes a winding jaw 12 that is positioned at the winding form 4 for winding the wire. The wire is fed to the winding form 4 by means of a flyer 14, which, for the purpose of winding the wire, performs a rotary movement about the axis of rotation of the winding device 10, controlled by a drive 16 of the flyer 14.

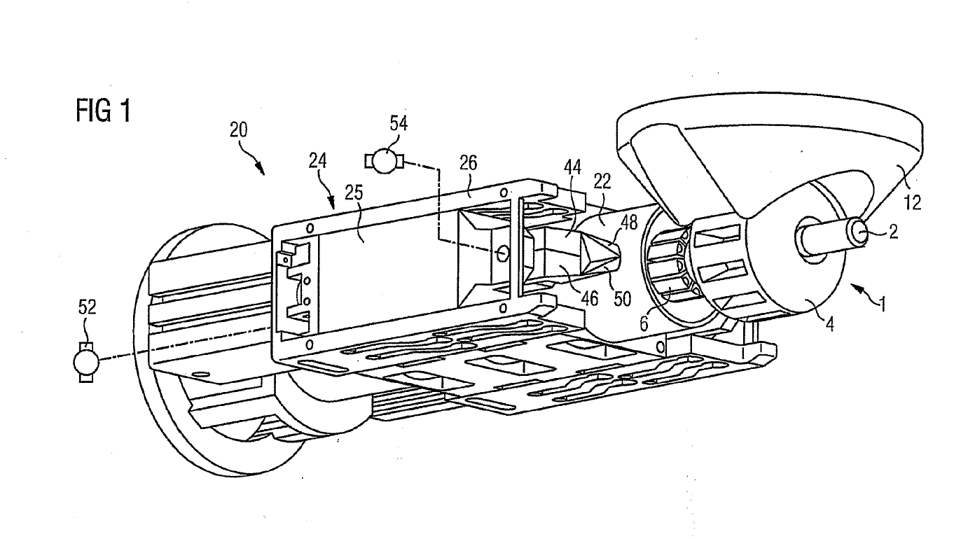

Also provided is a cutting device 20 that has a jacket member 22 (FIG. 1) with a jacket drive (not shown) by means of which the jacket member 22 can be displaced axially. The jacket member 22 is fashioned such that it can accommodate the commutator 6 on its one free end in such a way as to prevent the wire becoming caught up on the commutator 6 or one of the hooks 8 of the commutator 6 during the winding of the wire into the slot of the winding form 4.

Furthermore, the cutting device 20 has a cutting mechanism 24 that is fixed to the jacket member 22. The cutting mechanism 24 has scissors 25 and an associated drive which is configured so as to displace the scissors 25 in an axial direction relative to the jacket member 22 as well as in a direction having a radial direction component relative to the jacket member 22.

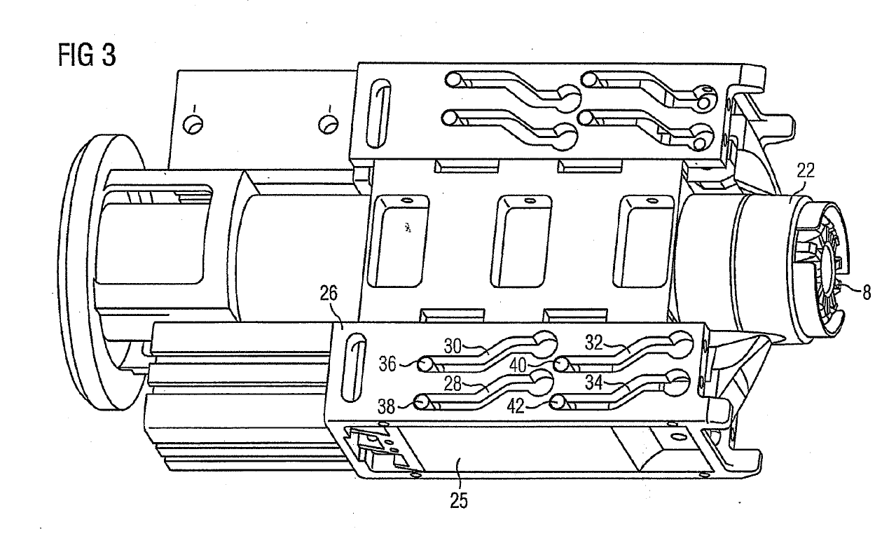

A slideway member 26 forms part of the drive for the scissors. The slideway member 26 has slideways 28, 30, 32, 34 to which pins 36, 38, 40, 42 of the scissors 25 are assigned. The pins 36, 38, 40, 42 engage in the slideways 28, 30, 32, 34. A movement caused by an actuator 52 of the drive for the scissors parallel to the axis of the jacket member 22 thus results initially, starting from the position of the pins 36, 38, 40, 42 as shown in FIG. 3, in an axial movement of the scissors 25 with reference to the jacket member 22, and following this a further movement in the axial and radial direction, that is to say, for example, a movement inclined at less than 45° relative to the axis of the jacket member 22, and finally once again a movement of the scissors 25 in the axial direction with reference to the jacket member 22. In this way the actuator 52 of the drive for the scissors 25 can be embodied very simply and yet the scissors 25 can perform a movement both in the axial direction and in the radial direction with reference to the axis of the jacket member 22.

Given suitable configuration of the slideways 28, 30, 32, 34, the scissors can then be displaced sufficiently far so as to protrude axially, with the first and second blades 48, 50 of its first and second blades 44, 46, beyond the free end of the jacket member 22, which is provided for accommodating the commutator 6. Furthermore, it can also be ensured by suitable configuration of the slideways 28, 30, 32, 34 that the blades 48, 50 are located, at the end of the movement of the scissors described above, very close radially to a respective commutator hook 8, the wire assigned to which hook is to be cut by means of the scissors.

Furthermore, an actuator 54 of the blades 44, 46 of the scissors 25 is provided for operating the blades 44, 46 for the purpose of cutting the wire. If the scissors are then located in a position in which the pins 36, 38, 40, 42 are at the end of the slideways 28, 30, 32, 34, in that they are not in the position indicated in FIG. 3, the scissors 25 are operated for the purpose of cutting the wire. The scissors 25 are then subsequently moved back again, by means of the drive for the scissors 25, to the position in which the pins 36, 38, 40, 42 are in the position shown in FIG. 3.

In place of the slideway member 26, the drive for the scissors 25 can, for example, also display one or more correspondingly fashioned actuators 52 of the drive for the scissors 25, which are fashioned such that they enable movements in the axial and the radial directions with reference to the axis of the jacket member 22. This can be ensured, for example, by means of two electric motor drives. However, this is substantially more costly than providing the slideway member 26.

In a simple embodiment of the slideway member, the slideways 28, 30, 32, 34 can also just be fashioned such that the scissors 25, in the case of a movement directed toward or beyond the axial end of the jacket member 22 via which the commutator can be inserted, initially perform an axial movement with reference to the jacket member 22 and then a movement having a radial component with reference to the jacket member 22, and have then already arrived at the position in which the wire is cut.

What is claimed is:

1. A cutting device comprising:
a jacket member that is embodied so as to selectively shield or expose a commutator of a rotor, and
a cutting mechanism that is fixed to the jacket member, the cutting mechanism comprising scissors and an associated drive for the scissors, which drive is configured so as to displace the scissors in an axial direction relative to the jacket member as well as in a direction having a radial direction component relative to the jacket member.

2. The cutting device as claimed in claim 1, wherein the drive for the scissors includes a slideway member with a slideway that is fashioned such that an axial movement of an actuator of the drive for the scissors is converted into a movement of the scissors in an axial direction and then into one with a radial direction component if the movement is directed toward or beyond the axial end of the jacket member via which the commutator can be inserted into the jacket member.

3. The method as claimed in claim 2, wherein the slideway is fashioned such that following the movement of the scissors taking place with a radial direction component, if the movement is directed toward or beyond the axial end of the jacket member via which the commutator can be inserted into the jacket member, a further axial movement of the scissors takes place.

4. The method for operating a cutting device with a jacket member, and a cutting mechanism having scissors and an associated drive for the scissors for displacing the scissors, comprising the steps of:
bringing the jacket member into a position in which the jacket member shields a commutator,
after winding a wire into a winding form of a rotor and then fastening the wire to a hook of the commutator, activating the drive for the scissors to move the scissors in an axial and radial direction toward or beyond the axial end of the jacket member via which the commutator can be inserted into the jacket member,
activating of the scissors to cut the wire, and
subsequently activating the drive for the scissors to move the scissors in the opposite direction back to their starting position.

5. The method as claimed in claim 4, further comprising the step of converting an axial movement generated by the drive for the scissors into a movement of the scissors in an axial direction and into one with a radial direction component if the movement is directed toward or beyond the axial end of the jacket member.

6. The method as claimed in claim 5, wherein the the step of converting is generated by a slideway fashioned such that following the movement of the scissors taking place with a radial direction component, if the movement is directed toward or beyond the axial end of the jacket member via which the commutator can be inserted into the jacket member, a further axial movement of the scissors takes place.

7. A cutting device comprising:
a jacket member which selectively shields or exposes a commutator of a rotor, and
a cutting mechanism comprising scissors and an associated drive for the scissors, wherein the drive displaces the scissors in an axial direction relative to the jacket member as well as in a direction having a radial direction component relative to the jacket member.

8. The cutting device as claimed in claim 7, wherein the cutting mechanism is fixed to the jacket member.

9. The cutting device as claimed in claim 7, wherein the drive for the scissors includes a slideway member with a slideway that converts an axial movement of an actuator of the drive for the scissors into a movement of the scissors in an axial direction and then into one with a radial direction component if the movement is directed toward or beyond the axial end of the jacket member via which the commutator can be inserted into the jacket member.

10. The method as claimed in claim 9, wherein the slideway is fashioned such that following the movement of the scissors taking place with a radial direction component, if the movement is directed toward or beyond the axial end of the jacket member via which the commutator can be inserted into the jacket member, a further axial movement of the scissors takes place.
